(19) United States
(12) Patent Application Publication
(10) Pub. No.: US 2024/0122398 A1
(43) Pub. Date: Apr. 18, 2024

(54) BEVERAGE SYSTEM HAVING INTERCHANGEABLE FLAVOR CONCENTRATE CARTRIDGES

(71) Applicant: SELAH BEVERAGES INC., Miami Beach, FL (US)

(72) Inventors: Joshua KUNIS, Miami Beach, FL (US); John Richard Laverack, Southberry, CT (US); Cobern Eugene McGraw, Startford, CT (US); Kurt Raymond Weseman, Hamden, CT (US)

(21) Appl. No.: 18/379,986

(22) Filed: Oct. 13, 2023

Related U.S. Application Data
(60) Provisional application No. 63/379,463, filed on Oct. 14, 2022.

(51) Int. Cl. A47J 31/40; A47J 31/44; A47J 31/46

(52) U.S. Cl. CPC A47J 31/407; A47J 31/404; A47J 31/4407; A47J 31/461

(57) ABSTRACT

A beverage system includes a vessel having a chamber for retaining a volume of diluent such as water, and at least one assembly for expressing aliquots of flavor concentrate from a flavor concentrate cartridge into the diluent. Flavor concentrate is expressed from the cartridge by actuating a sliding pawl that moves a ratchet bar to depress a plunger on the cartridge. Cartridges of flavor concentrate are inserted into the beverage system and spent cartridges are removed upon depletion. In this manner a user can customize the volume and ratio of flavor and additives in their beverage.

### CROSS-REFERENCE TO RELATED APPLICATIONS

This application claims the benefit of U.S. Provisional Patent Application 63/379,463 entitled BEVERAGE SYSTEM HAVING INTERCHANGEABLE FLAVOR CONCENTRATE CARTRIDGES, which was filed Oct. 14, 2022. The provisional patent application is incorporated by reference in its entirety.

### BACKGROUND OF THE INVENTION

The present invention generally relates to beverage technology, and more specifically, to beverage systems having interchangeable flavor concentrate cartridges.

In the United States the non-alcoholic beverage industry brings in roughly $225 billion in revenue each year, with the general trend being that Americans are drinking less soda but more water. As water has become more popular a variety of specialized waters have evolved including flavored waters which are waters with natural and/or artificial flavors added for taste enhancement, and functional waters that include vitamins, minerals, caffeine, electrolytes, and/or other infusions that purport to provide health benefits. The global flavored water market size grew from $23.44 billion in 2021 to $25.59 billion in 2022, and is projected to be $27.93 billion in 2023.

The transition from soda to water and specialized water has been positive from a health perspective but has had very negative environmental implications. More than 60 million plastic water bottles end up in landfills and incinerators every day in the US, which equates to approximately almost 22 billion per year. It has been estimated that the impact of bottled water on natural resources is 3,500 times higher than for tap water.

The significant environmental damage inflicted by disposable water bottles has brought about a demand for reusable water bottles, but these bottles are typically simple liquid vessels. A consumer fills their bottle with water or a pre-prepared beverage, consumes the liquid, washes the bottle, and repeats. This isn't ideal for reusable water bottle users who want to customize their drink.

People's preferences in drinks, and flavored waters in particular, vary a lot. By way of example children tend to prefer colorful, highly flavored and sweet tasting water, while adults generally opt for something more subtle. Unfortunately, however, there are limited options for reusable water bottle users to customize their water. They can refill their bottle with a pre-prepared flavored water of their choosing but pre-prepared waters come bottled, which negate the environmental benefits of reusable bottles. Alternatively one can add one or more flavor concentrates to their bottle of water and agitate, but that introduces the inconvenience and mess of using and storing a separate concentrate.

As can be seen, there is a need for a reusable beverage system that allows a user to customize their flavored water with respect to specific flavors, blends of flavors, and ratio of concentrate to diluent. It is also desirable that this system allows a user to readily identify concentrates available for use. Finally, it is desirable that this system is environmentally friendly and easy to use.

### SUMMARY OF THE INVENTION

A beverage system includes a vessel having a chamber for retaining a volume of diluent such as water, and at least one and preferably two assemblies for expressing aliquots of flavor concentrate from a flavor concentrate cartridge into the diluent. These assemblies are preferably on opposing sides of the vessel. Flavor concentrate is expressed from each cartridge by actuating a sliding pawl that is located on the outside of the vessel. The sliding pawl moves a ratchet bar which depresses a plunger on the bottom end of the cartridge, thereby pushing the flavor concentrate upwards and through a valve located on the top end of the cartridge. Cartridges of flavor concentrate are inserted into the beverage system through doors located on the outside of the vessel, and spent cartridges are removed through those same doors, typically upon depletion of the flavor concentrate. In one embodiment the flavor concentrate cartridges are disposed of after depletion of the concentrate within. This system allows a user to customize the volume and ratio of flavor and additives in their beverage.

### BRIEF DESCRIPTION OF THE DRAWINGS

FIG. 1 depicts a perspective view of a beverage system of the present invention;

FIG. 2 depicts a side view of a beverage system of the present invention;

FIG. 3 depicts a cross-sectional view of a beverage system taken along A-A of FIG. 2;

FIG. 4 depicts a side view of a beverage system of the present invention;

FIG. 5 depicts a cross-sectional view of a beverage system taken along B-B of FIG. 4;

FIG. 6 depicts an exploded view of a beverage system;

FIG. 7 depicts a perspective view of a vessel lid;

FIG. 8 depicts a side view of a vessel lid;

FIG. 9 depicts a top view of a vessel lid;

FIG. 10 depicts a cross-sectional view of a vessel lid taken along C-C of FIG. 9;

FIG. 11 depicts an exploded view of a vessel lid;

FIG. 12 depicts a perspective view of a vessel;

FIG. 13 depicts a side view of a vessel;

FIG. 14 depicts another side view of a vessel;

FIG. 15 depicts a cross-sectional view of a vessel taken along D-D of FIG. 14;

FIG. 16 depicts a top view of a vessel;

FIG. 17 depicts a bottom view of a vessel;

FIG. 18 depicts a side view of a cartridge;

FIG. 19 depicts another side view of a cartridge;

FIG. 20 depicts a cross-sectional view of a cartridge taken along E-E of FIG. 19;

FIG. 21 depicts an enlarged cross-sectional view of a cartridge cap from section F of FIG. 20;

FIG. 22 depicts an exploded view of a cartridge;

FIG. 23 depicts a cross slit valve;

FIG. 24 depicts another cross slit valve;

FIG. 25 depicts a perspective view of a cartridge cap;

FIG. 26 depicts another perspective view of a cartridge cap;

FIG. 27 depicts a side view of a cartridge cap;

FIG. 28 depicts another side view of a cartridge cap;

FIG. 29 depicts a cross-sectional view of a cartridge cap taken along G-G of FIG. 28;

FIG. 30 depicts a top view of a cartridge cap;

FIG. 31 depicts a cross-sectional view of a cartridge cap taken along H-H of FIG. 30;

FIG. 32 depicts a top view of a cartridge cap;

FIG. 33 depicts a perspective view of a cam lever;

FIG. 34 depicts a front view of a cam lever;

FIG. 35 depicts a top view of a cam lever;

FIG. 36 depicts a side view of a cam lever;

FIG. 37A depicts a first side of the beverage system with a first door closed;

FIG. 37B depicts a user posed to open a first side;

FIG. 37C depicts the first door open and the first cartridge poised for insertion;

FIG. 37D depicts the first cartridge inserted and raised within the cartridge housing;

FIG. 37E depicts the first ratchet bar raised to an engagement position with the first cartridge;

FIG. 37F depicts the first ratchet bar engaged with the first cartridge and the first door being closed;

FIG. 37G depicts disengaging the vessel lid;

FIG. 37H depicts adding water to the vessel;

FIG. 37I depicts reengaging the vessel lid; and

FIG. 37J depicts the release of flavor concentrate by actuating a first sliding pawl;

FIG. 38 depicts a side view of a beverage system with a door open;

FIG. 39 depicts a cross-sectional view of the beverage system taken along Hof FIG. 38;

FIG. 40 depicts an enlarged view of section J of FIG. 38;

FIG. 41 depicts a side view of a beverage system with two doors open;

FIG. 42 depicts a cross-sectional view of the beverage system taken along K-K of FIG. 41;

FIG. 43 depicts a top view of a beverage system with doors open and lid removed; and

FIG. 44 depicts a bottom view of a beverage system with doors open.

The following detailed description is of the best currently contemplated modes of carrying out exemplary embodiments of the invention. The description is not to be taken in a limiting sense, but is made merely for the purpose of illustrating the general principles of the invention. The scope of the invention is best defined by the appended claims.

Broadly, the present invention is a system for storing a volume of diluent and at least one concentrate cartridge, and for adding aliquots of the concentrate(s) to the diluent to form a mixture. In a preferred embodiment the diluent is water and at least one cartridge includes a flavor concentrate with the resulting mixture being a beverage. The ratio of concentrate(s) to diluent is controlled by the user, thereby allowing the user to customize their beverage to their liking.

As used herein “water” and “diluent” may be used interchangeably but it should be understood that the system can employ various types of liquids as diluents including purified, tap, naturally sourced, carbonated, non-carbonated, fortified, and flavored waters, as well as other liquids including coffee, animal milk, plant-derived milk, alcoholic spirits, fermented products, and pre-prepared beverages.

Also, as used herein “flavor” and “concentrate” may be used interchangeably but it should be understood that the system can employ various types of additives including vitamins, minerals, colorants, caffeine, electrolytes, medicants, purification agents, anti-microbial agents, stabilizers, clarifiers, and preservatives.

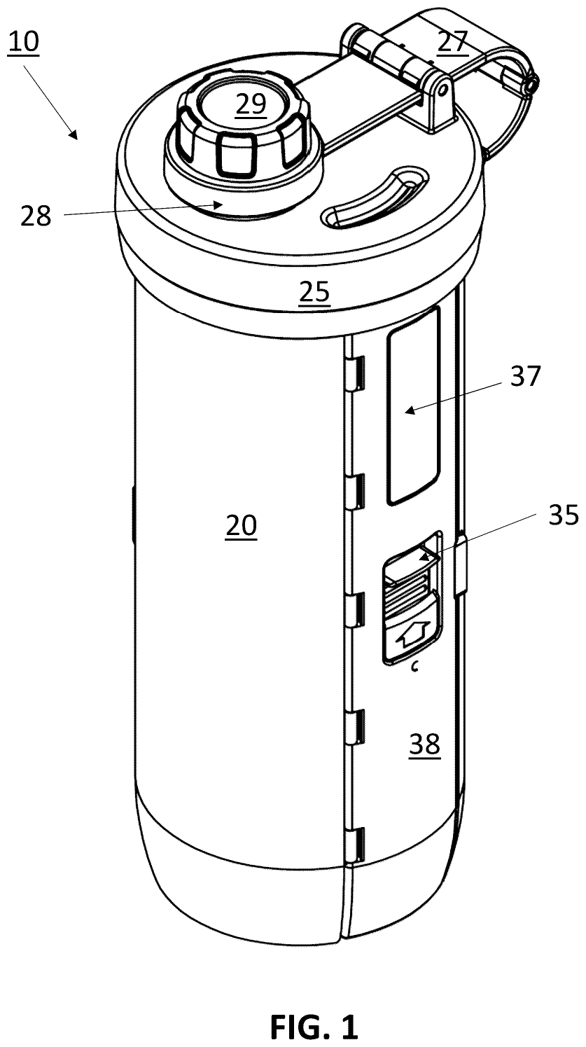

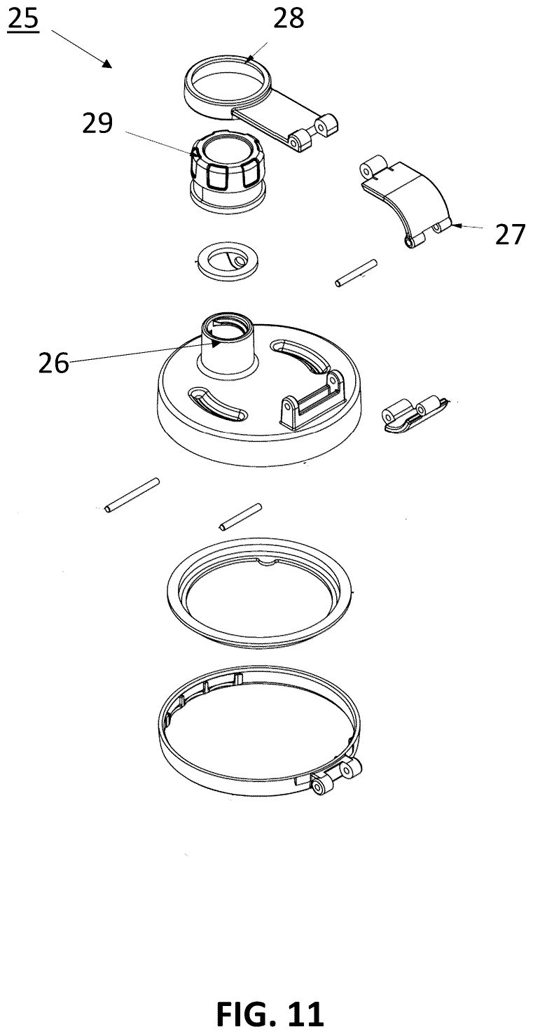

Referring to FIG. 1, beverage system 10 generally includes vessel 20 with vessel lid 25 releasably enclosing an open end of the vessel. Vessel lid 25 is connected to spout cover tether 28 by hinged arm 27. Spout cover tether 28 connects to spout cover 29, which releasably engages with vessel spout 26 (see FIG. 11). In ordinary use a user may consume liquid via vessel spout 26. Other major components of the system viewable from the exterior include at least one transparent or semi-transparent viewing window 37, at least one door 38, and at least one sliding pawl 35.

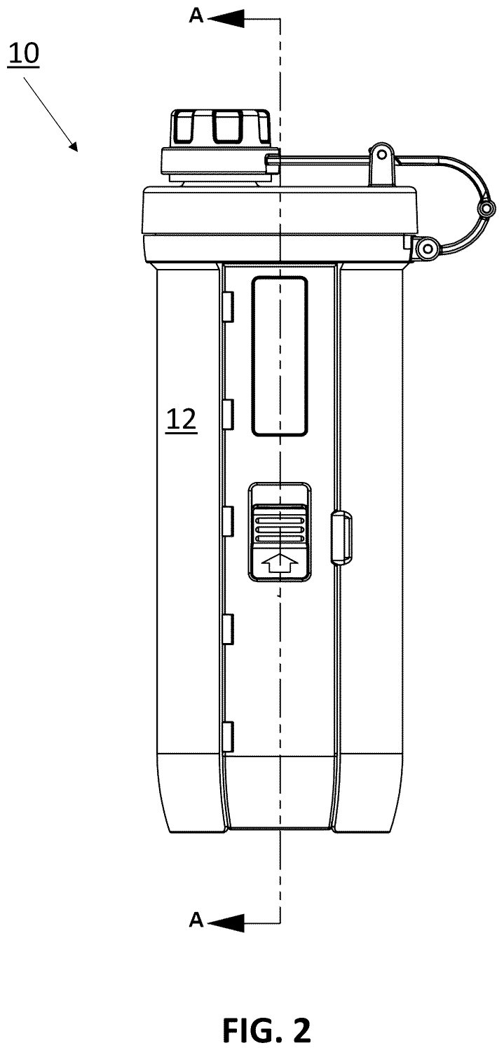

FIG. 2 depicts first side 12 of beverage system 10. Second side 14 (not shown) is located opposite of first side 12, and is substantially identical with respect to structure and function. For simplicity the invention will be described with respect to the structures correlating with first side 12, but it should be understood that the description likewise applies to analogous duplicative structures of second side 14.

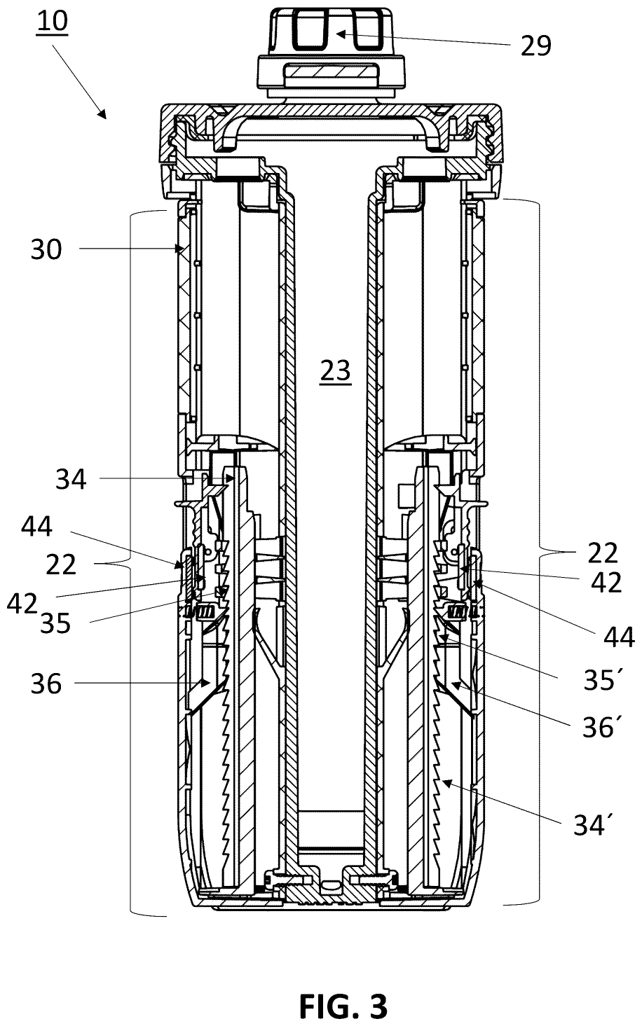

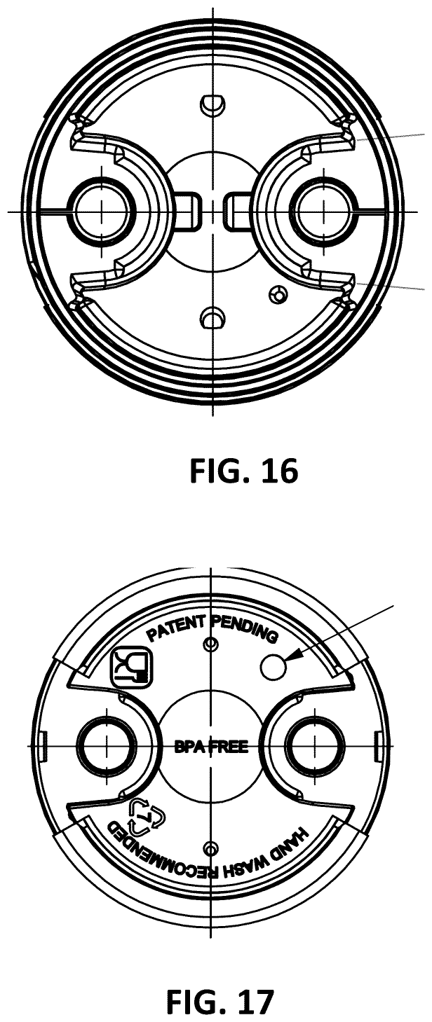

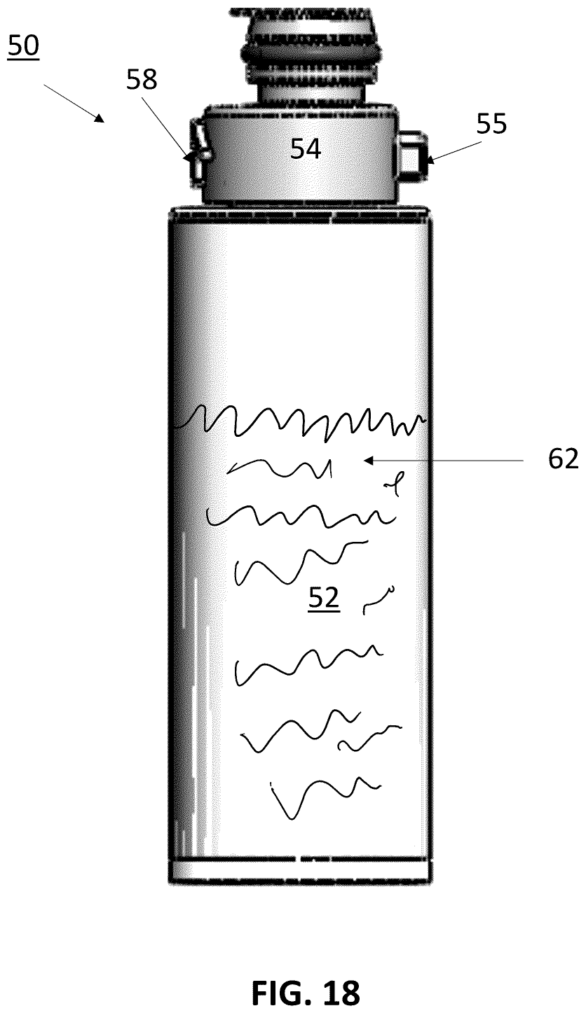

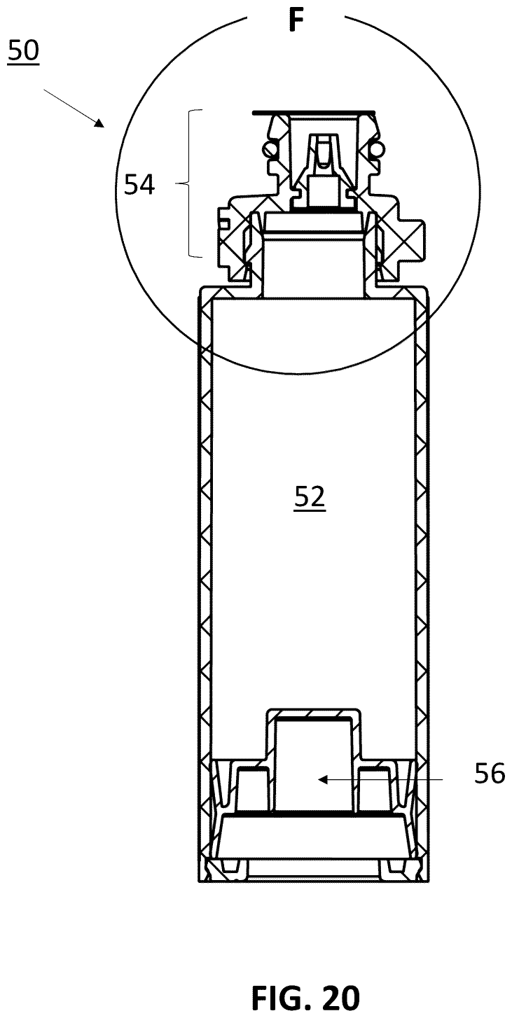

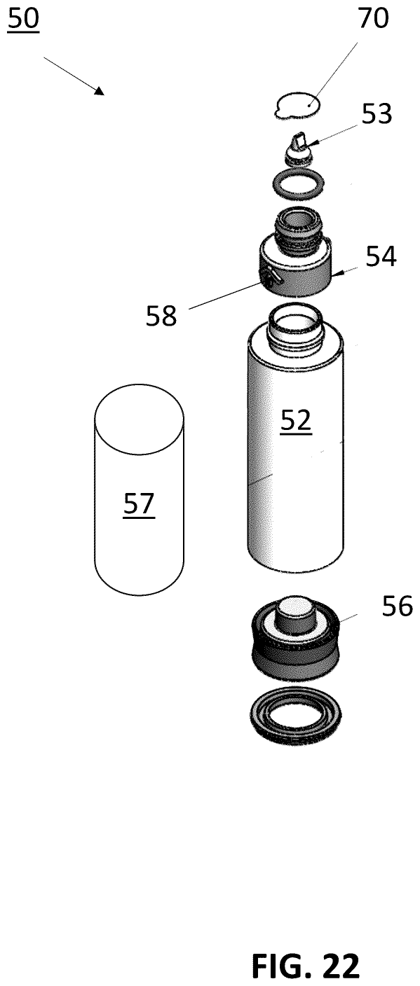

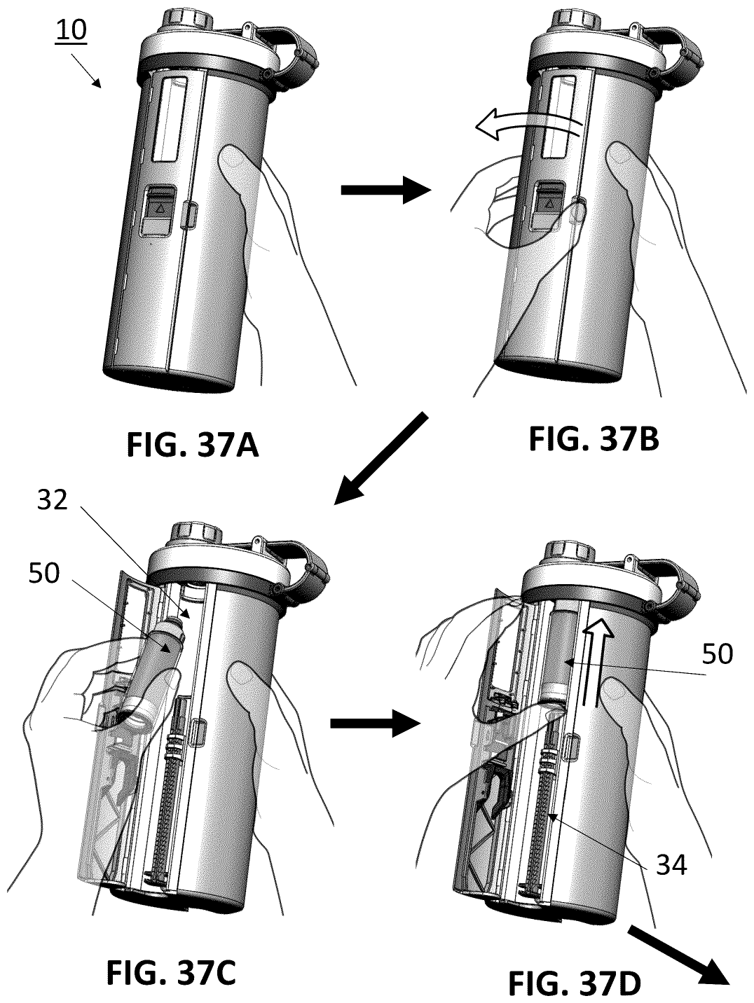

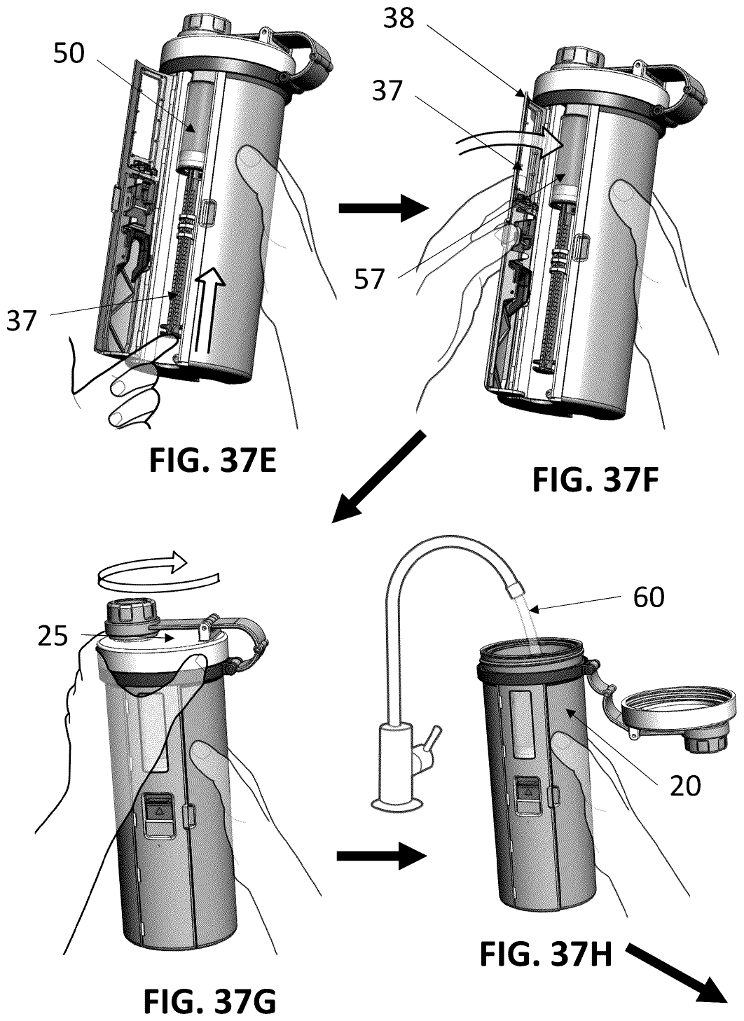

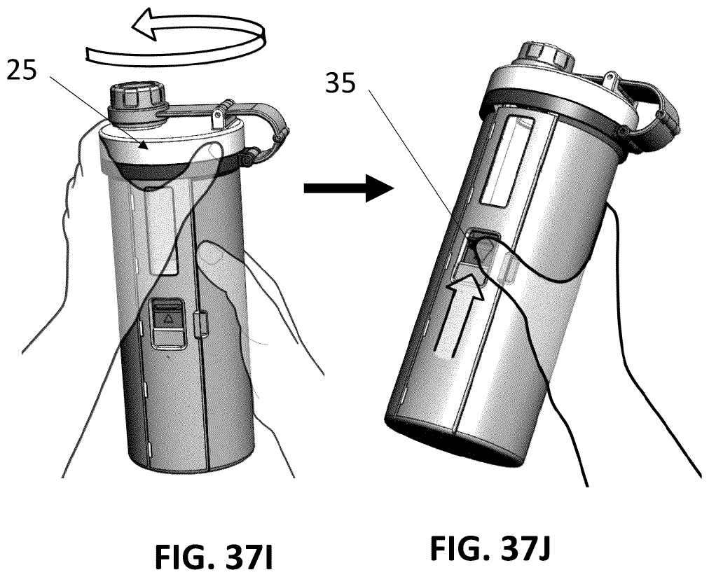

FIG. 3 depicts a cross-sectional view of a beverage system taken along A-A of FIG. 2 showing diluent/beverage chamber 23, and two longitudinal channels 22 retaining two cartridge housings 32 which generally house the cartridge assemblies 30. Each cartridge assembly 30 includes structures associated with storing and introducing the flavor concentrate into the diluent including at least one ratchet bar 34 that can be raised or lowered by actuating spring-loaded sliding pawl 35 to drive rachet bar 34 over fixed pawl 36. Rachet bar 34 presses plunger 56 (see FIGS. 20 and 22) to expel flavor concentrate 62 of cartridge 50 (see FIG. 18) into diluent 60 (see FIG. 37H). To reset rachet bar 34, typically when flavor concentrate has been depleted, door 38 is opened and fixed pawl 36 and sliding pawl 35 are disengaged so bar 34 can be manually reset to remove an empty cartridge and reset for a new full cartridge.

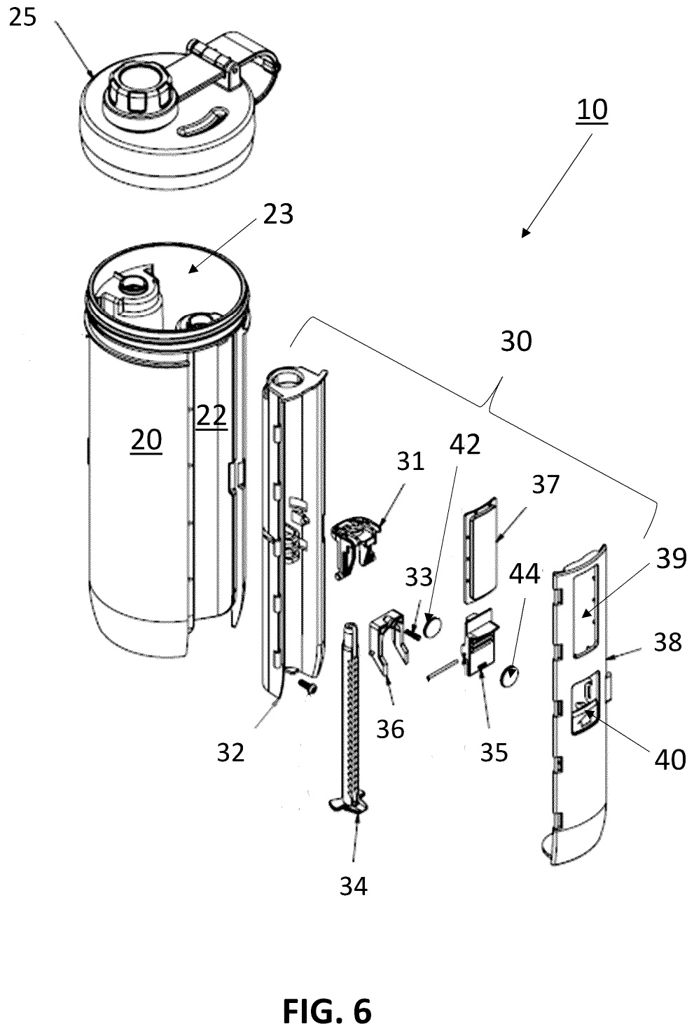

A preferred embodiment includes a magnetic spring mechanism that is part of the return mechanism for sliding pawl 35 and the door 38. Referring to FIGS. 3 and 6, two epoxy coated wafer shaped magnets, inner magnet 42 and outer magnet 44 are mounted to sliding pawl 35 and door 38, respectively. The magnet axes are normal to the flat faces and are mounted such that dissimilar poles face each other and exhibit an attracting force. When at rest inner magnet 42 and outer magnet 44 are held via mounts and hard stops with the poles intentionally misaligned, effectively creating a magnetic derived spring attracting force because the axes of the magnets want to align via their magnetic fields. When sliding pawl 35 is pressed upward to dispense fluid from cartridge 50, this intentional misalignment of axes increases in distance. Through the entire range of motion, the magnets remain close enough to exhibit enough attracting force to each other to easily overcome any friction or any other inefficiencies in the mechanism. Once the pawl is released, it automatically resets to its starting position due to the magnets' attractive forces.

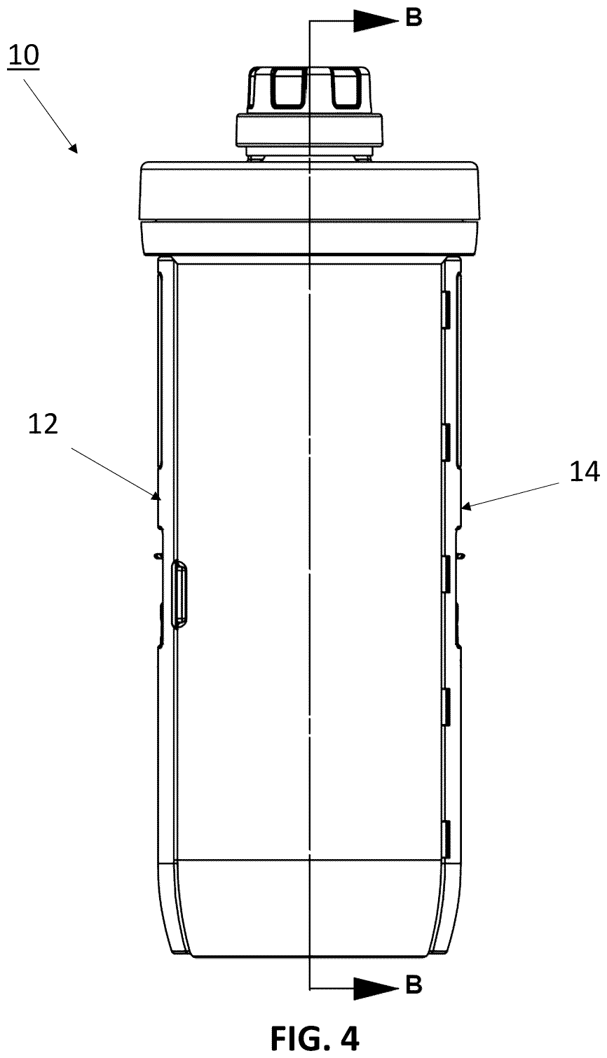

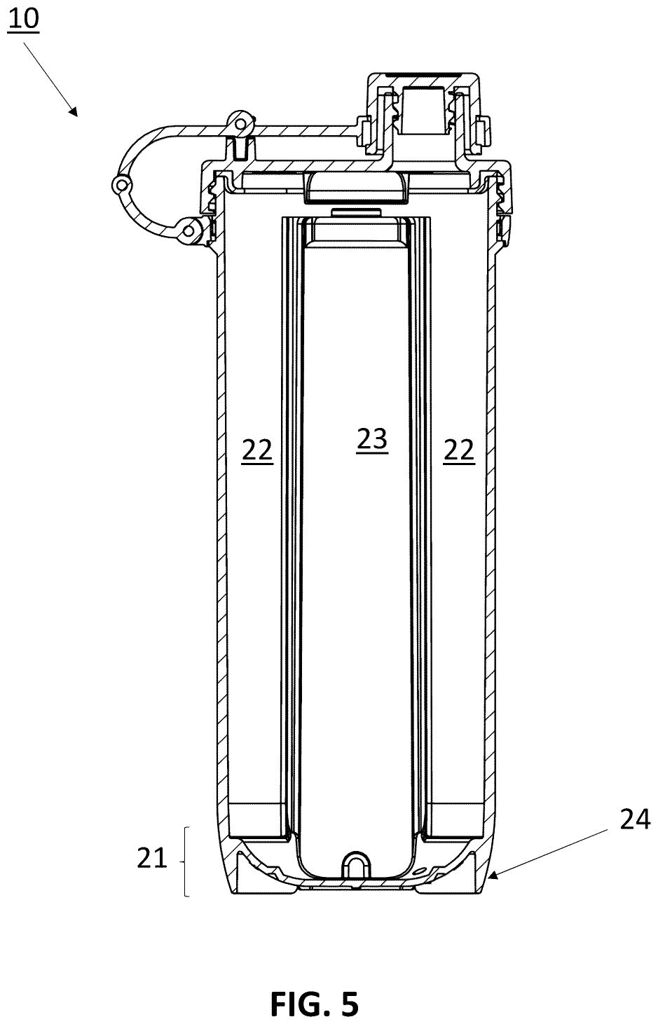

FIG. 4 depicts first side 12 and second side 14 in profile. FIG. 5 depicts a cross-sectional view of beverage system 10 taken along B-B of FIG. 4, showing diluent/beverage chamber 23 that holds diluent and/or beverage, longitudinal channels 22, and tapered bottom 21 which preferably includes bumper rib 24 for improved durability and drop performance.

FIG. 6 depicts an exploded view of beverage system 10 and notably demonstrates that vessel 20 defines at least one and preferably two longitudinal channels 22 (only one of which is numbered), each of which accommodate a single cartridge assembly 30. Cartridge assembly 30 includes cartridge housing 32 that maintains ratchet bar 34 and ancillary structures including springs 33, sliding pawl 35 and fixed pawl 36. Cartridge assembly releasably engages cartridge 50 (not shown) upon insertion. Door 38 is preferably connected by a hinge (unnumbered) to cartridge housing 32 and defines window aperture 39 for retention of viewing window 37. Door 38 also defines sliding pawl aperture 40, through which a portion of sliding pawl 35 protrudes for manipulation by user to actuate the delivery of aliquots of concentrate.

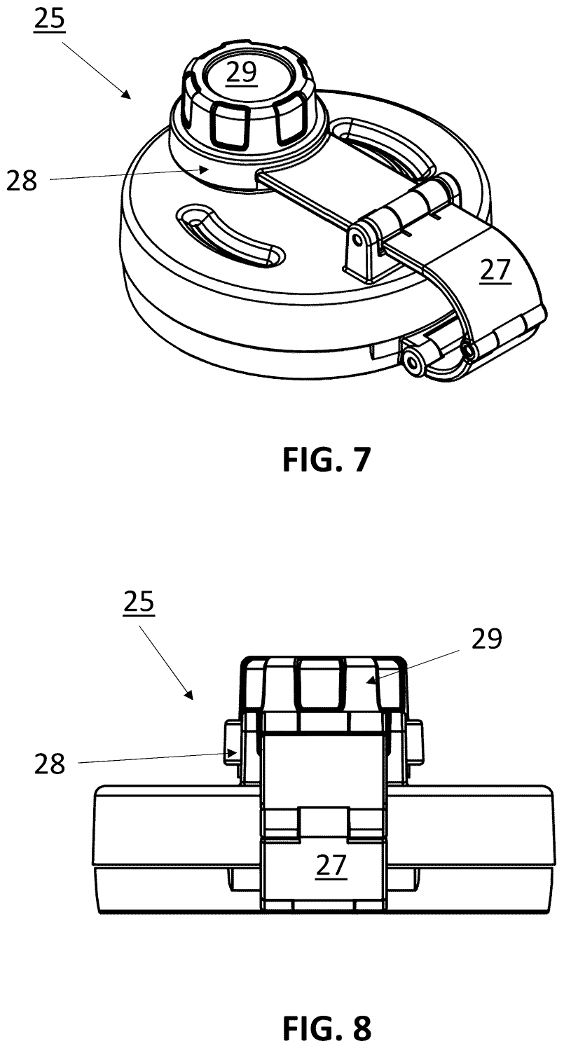

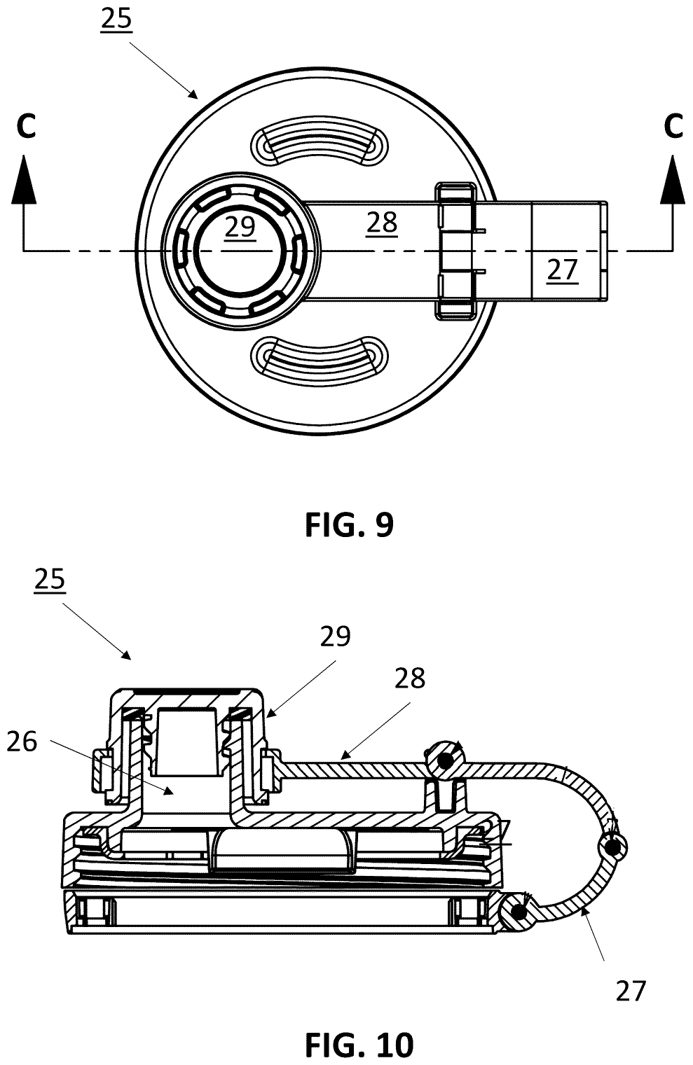

FIGS. 7, 8 and 9 depict perspective, side and top views, respectively, of vessel lid 25 including hinged arm 27 preferably including three hinges, and spout cover tether 28 for retaining spout cover 29. FIG. 10 depicts a cross-sectional view of vessel lid 25 taken along C-C of FIG. 9 and illustrates a preferred embodiment wherein spout cover 29 releasably engages with underlying vessel spout 26 by corresponding threads (unnumbered). In this embodiment spout cover 29 is removed from and reconnected to vessel spout 26 by unscrewing and screwing, for example when a user takes a drink.

FIG. 11 depicts vessel lid 25 in an exploded view including vessel spout 29. When assembled, spout cover tether 28 releasably engages with vessel lid and hinged arm 27. Vessel spout 26 extends upwardly and is the structure from which a user will generally take a sip. Threads, unnumbered, are defined by the inner circumference of the spout. Various gaskets and pins are shown but not numbered.

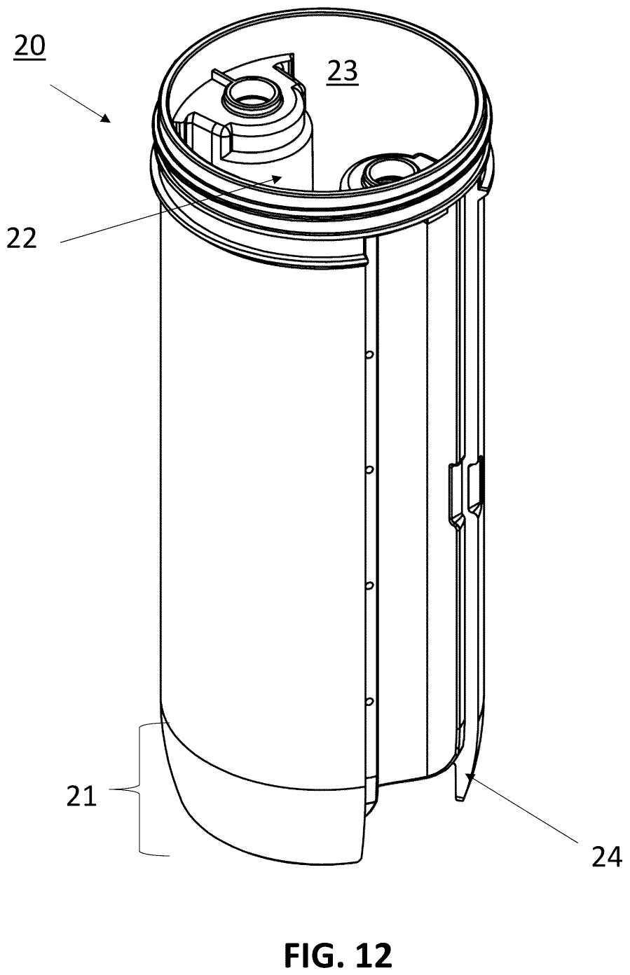

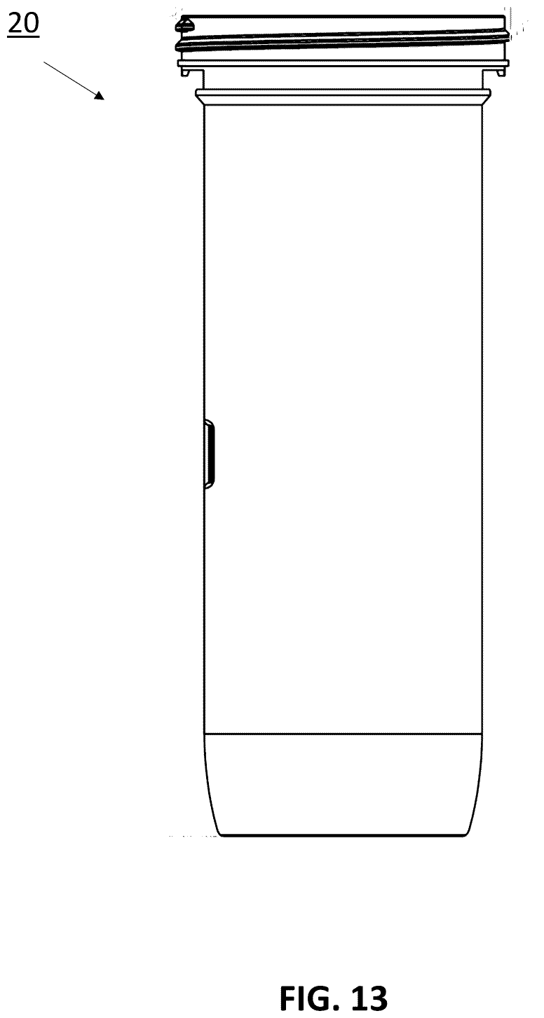

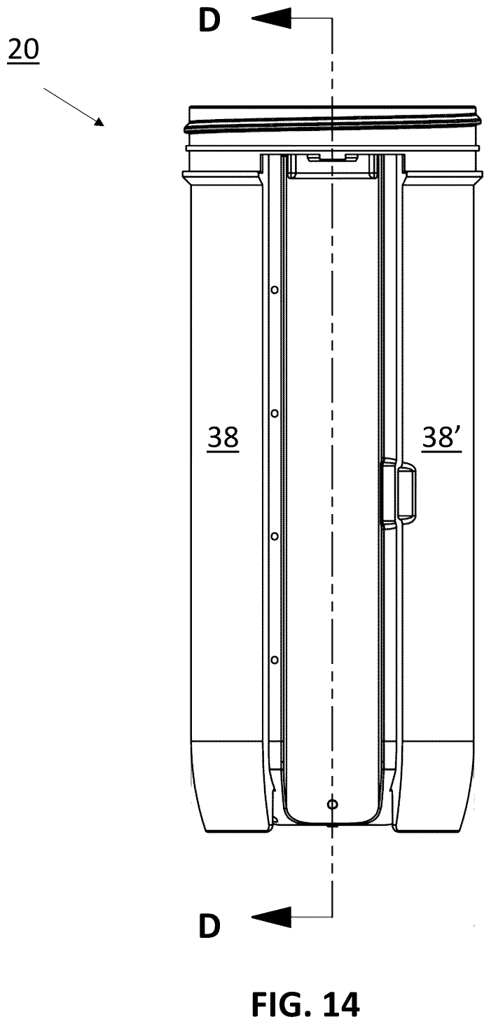

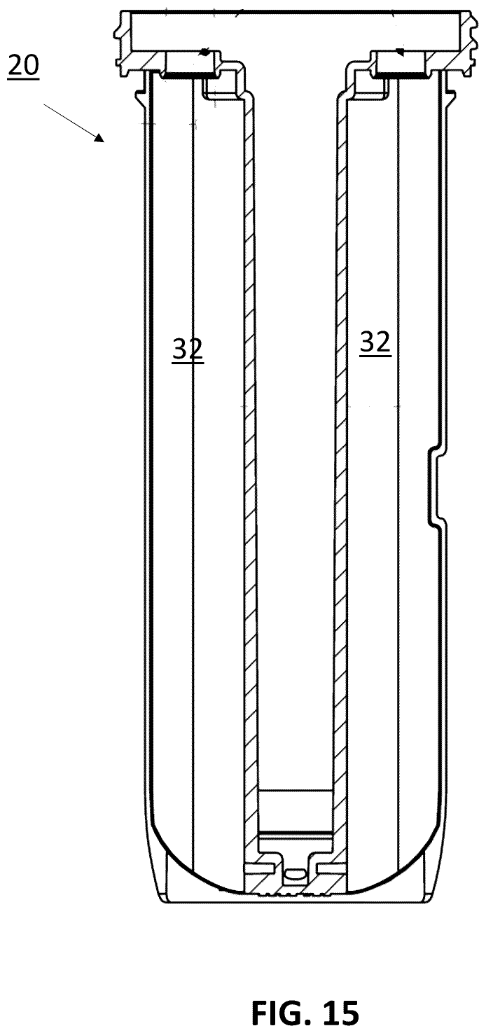

FIG. 12 is a perspective view of vessel 20 including diluent/beverage chamber 23 and two longitudinal channels 22. Tapered bottom 21 includes bumper rib 24. FIG. 12 depicts a side view of vessel 20, including unnumbered threads defined by the upper portion for engaging vessel lid 25. FIG. 14 depicts vessel 20 with first and second doors 38, 38′ respectively, and FIG. 15 depicts a cross-sectional view of a vessel taken along D-D of FIG. 14, showing two cartridge housings 32.

FIG. 16 is a top view of vessel 20 with the lid removed, and FIG. 17 is a bottom view of the vessel.

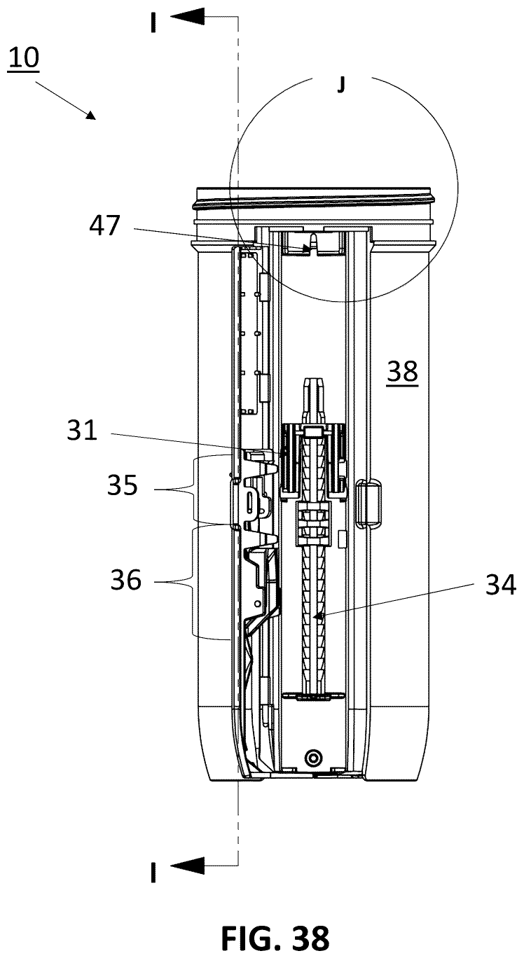

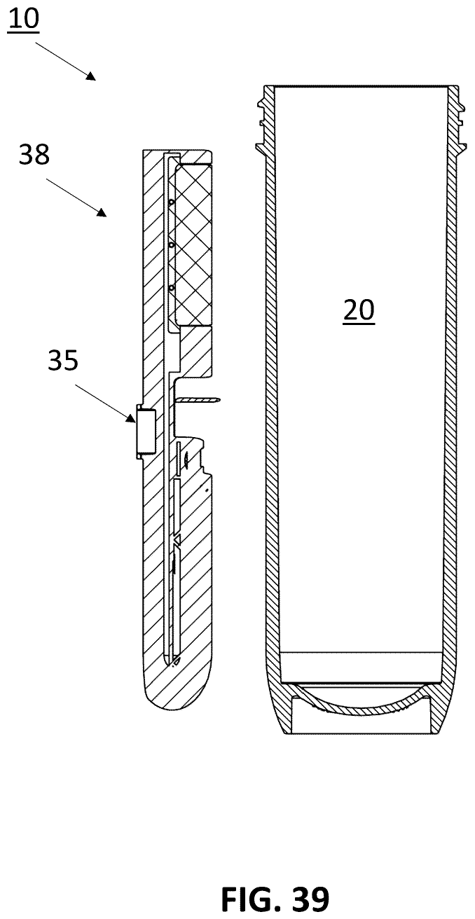

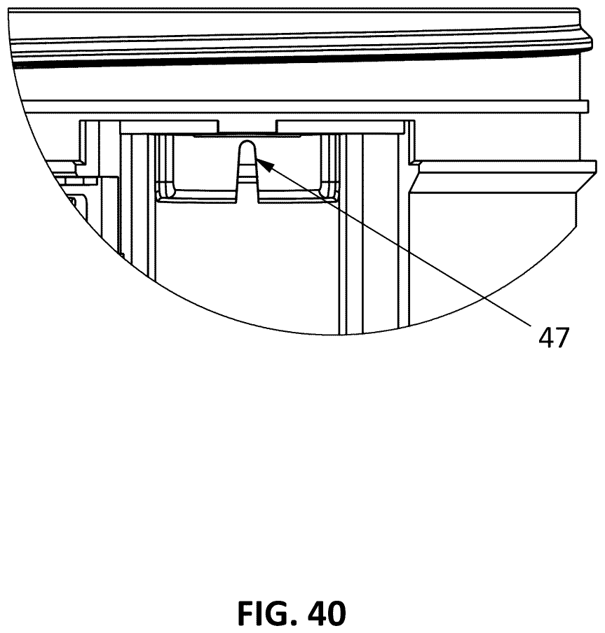

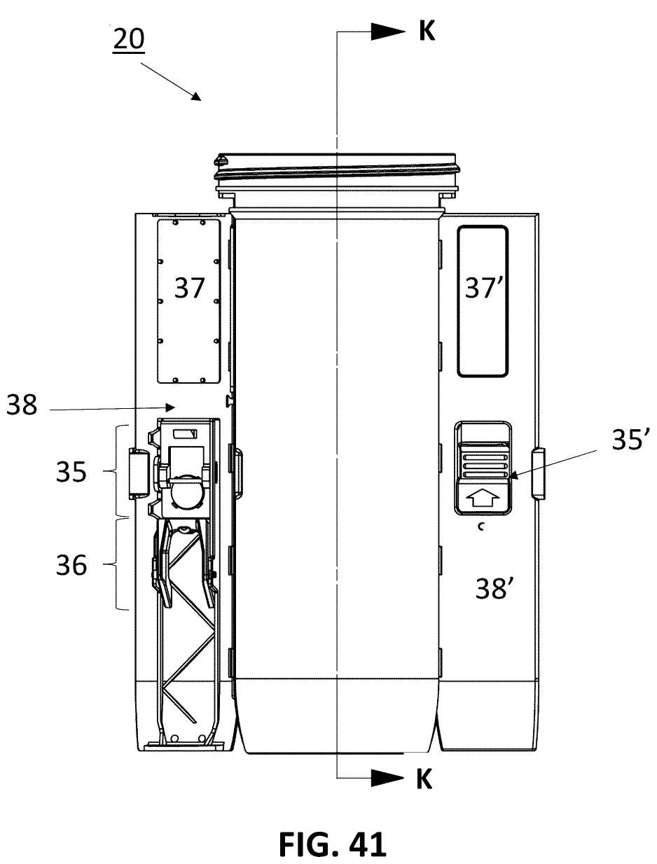

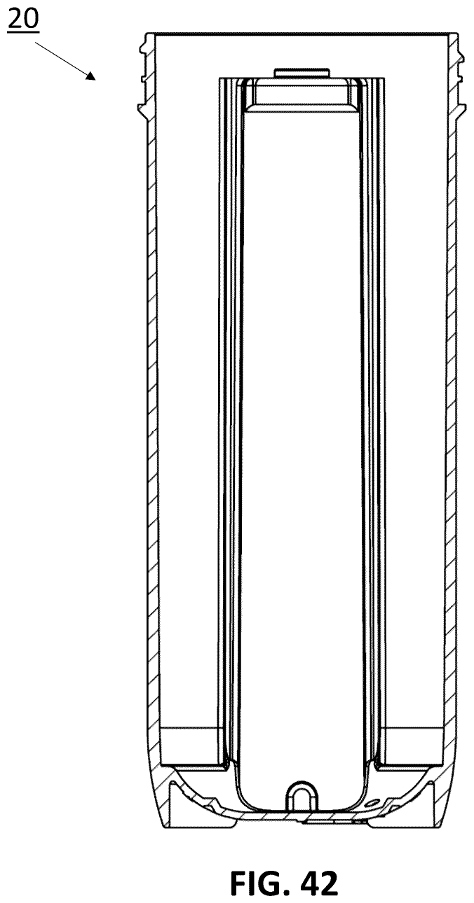

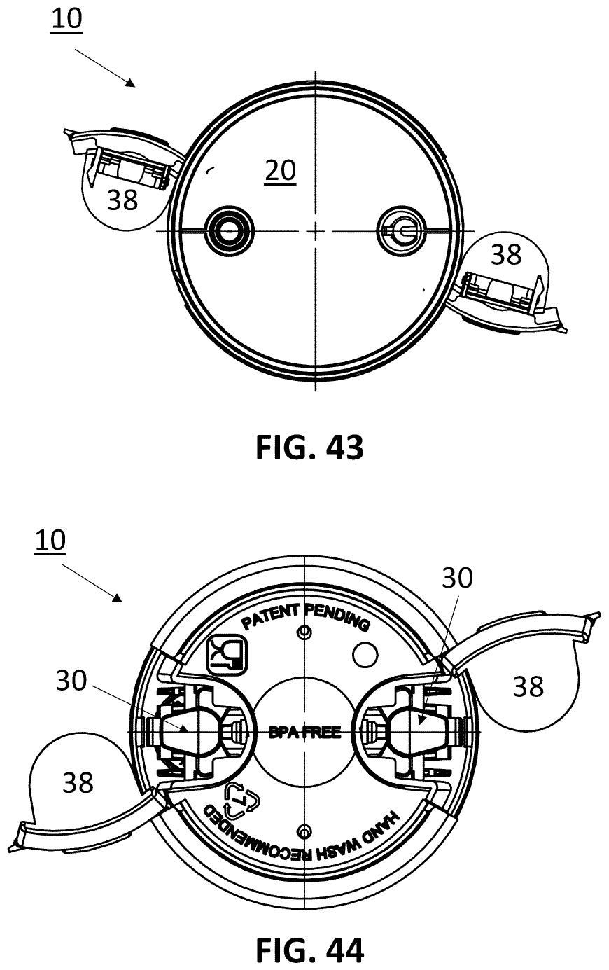

FIG. 18 depicts a side view of cartridge 50 including flavor receptacle 52 containing a volume of flavor concentrate 62, and cartridge cap 54 engaged with the top portion of the assembly. In a preferred embodiment cartridge cap 54 defines at least one alignment protrusion 55 that releasably mates with alignment protrusion receiver 47 (FIGS. 38 and 42) in cartridge housing 32. In a preferred embodiment alignment protrusion receiver 47 is a notch. The alignment protrusion to alignment protrusion receiver interaction ensures correct insertion of cartridge 50 into cartridge housing 32 thereby permitting actuation of plunger 56 and proper expression of flavor concentrate 62 into diluent.

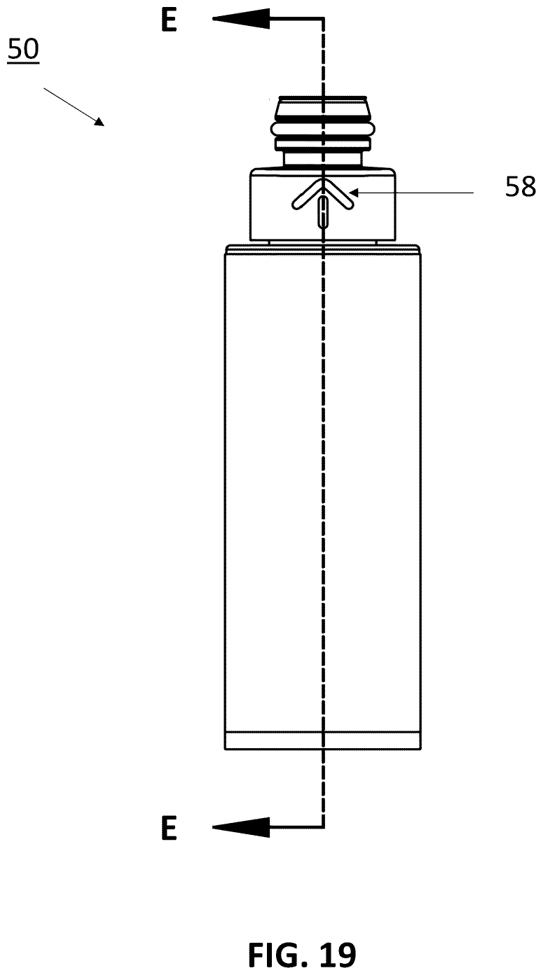

Referring to FIG. 19, cartridge 50 includes alignment marker 58, for example an arrow. In a preferred embodiment alignment marker 58 faces outwardly, and therefore is visible, upon insertion into cartridge housing 32. This provides gross alignment of cartridge 50. One or more alignment protrusions 55 (FIG. 18) provide fine positional alignment. Correct insertion of cartridge 50 ensures proper flavor concentrate expression and visibility of label through viewing window 37 (FIG. 1).

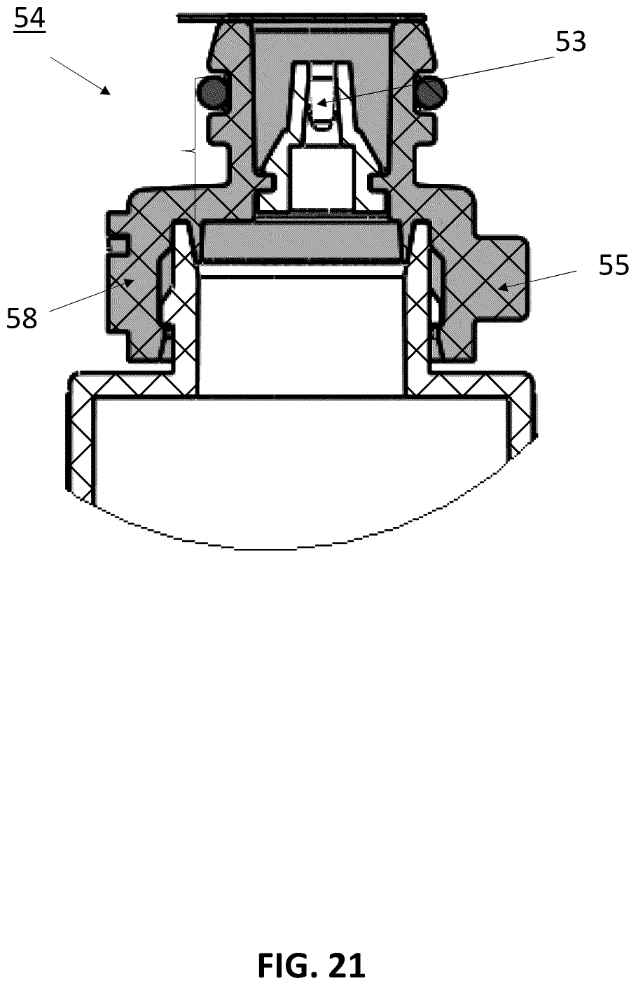

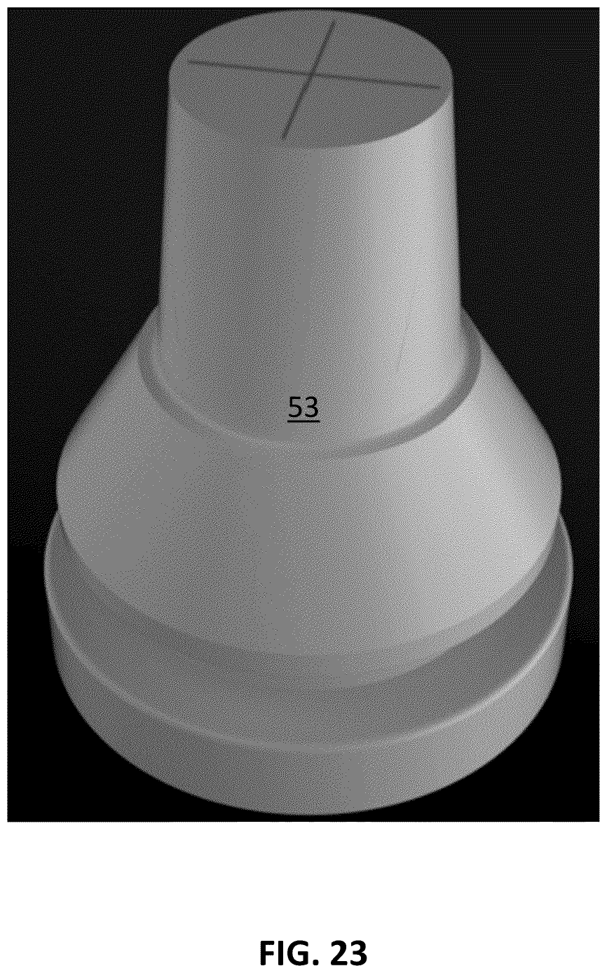

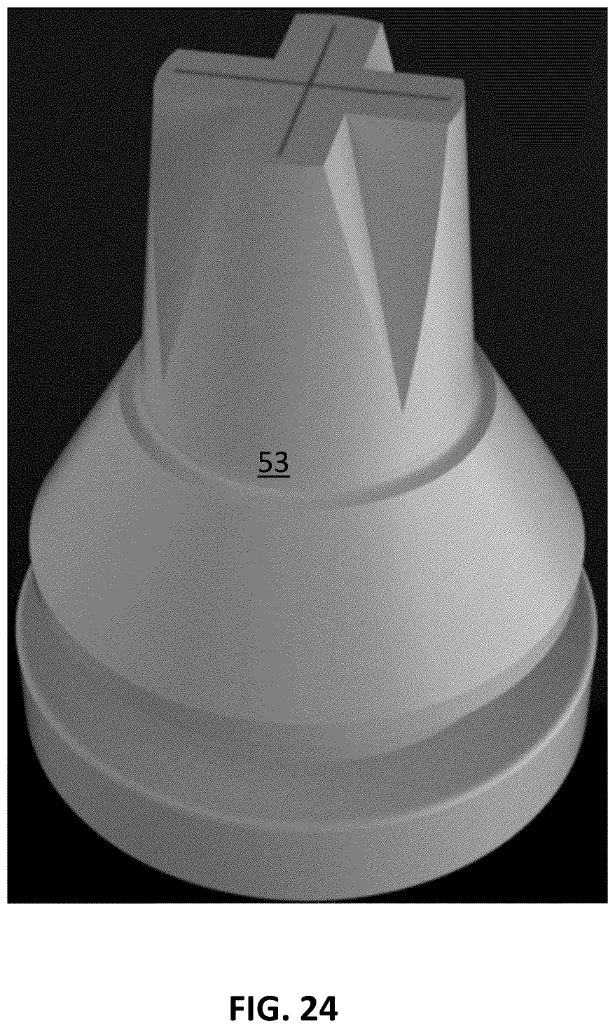

FIG. 20 depicts a cross-sectional view of a cartridge taken along E-E of FIG. 19. In use plunger 56 is pushed upwardly by ratchet bar 34 (see FIG. 3) towards cartridge cap 54 to incrementally expel flavor concentrate out of cross slit valve 53 (see FIG. 21) into diluent. FIG. 7 depicts and exploded view of a cartridge including plunger 56 which slides along the length of flavor receptacle 52 to expel flavor concentrate through valve 53 of cartridge cap 54. A preferred embodiment includes cap heat seal cover 70 to prevent unwanted leakage prior to use. Label 57 is preferably printed and can identify the flavor, additive and/or manufacturer, and/or depict fanciful graphics, instructions, and/or insertion markers. It is also within the scope of the invention to include multiple labels positioned around the perimeter of the cartridge, or a single label with a repeating design positioned around the perimeter of the cartridge. FIG. 22 also depicts ancillary gaskets and seals (unnumbered). FIGS. 23 and 24 depict several cross slit valves that are within the scope of the invention.

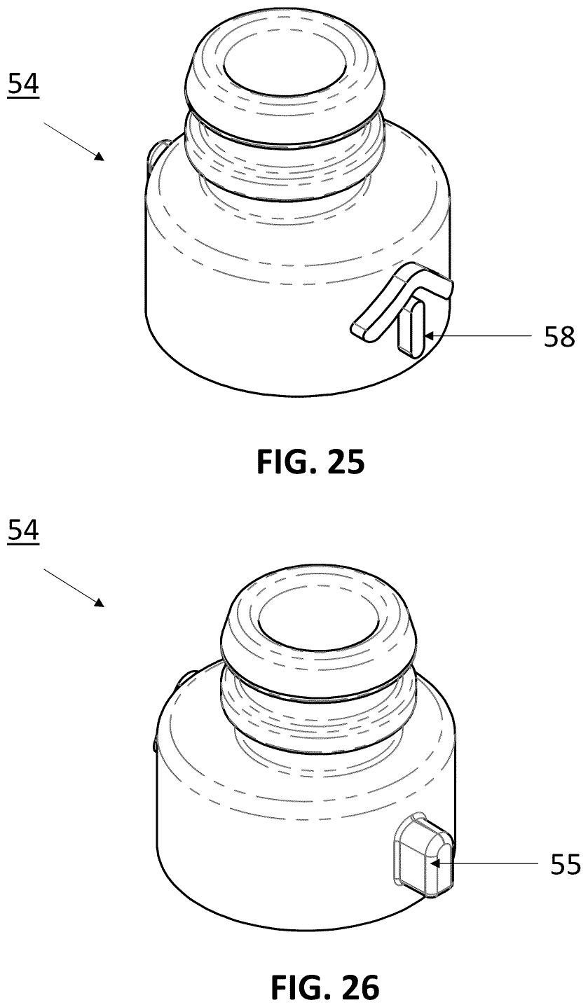

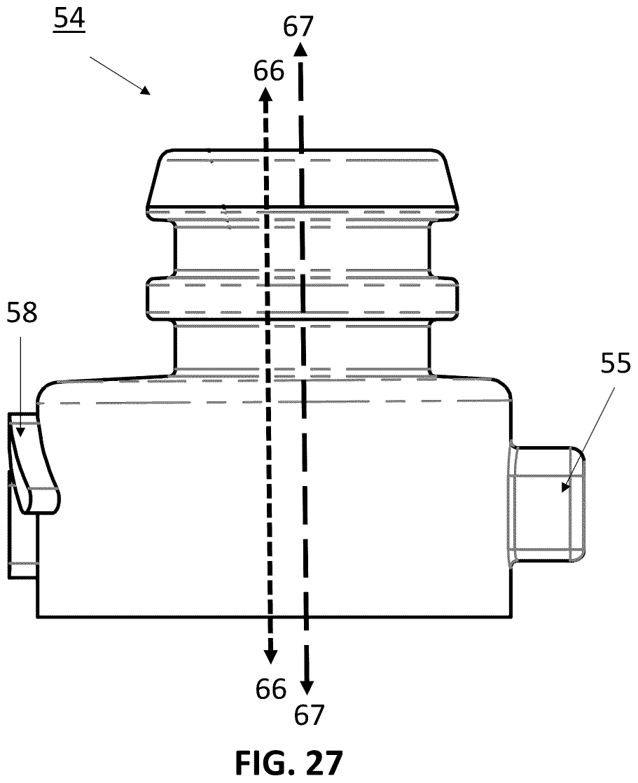

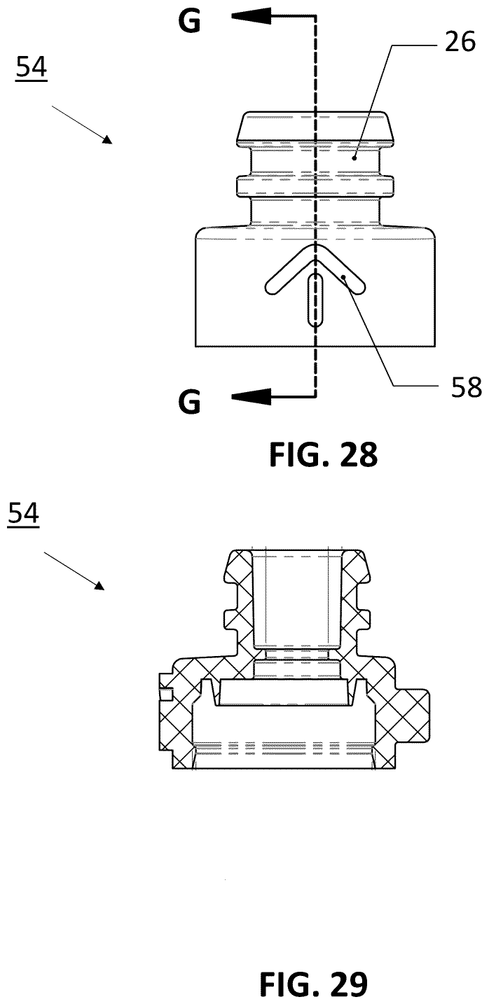

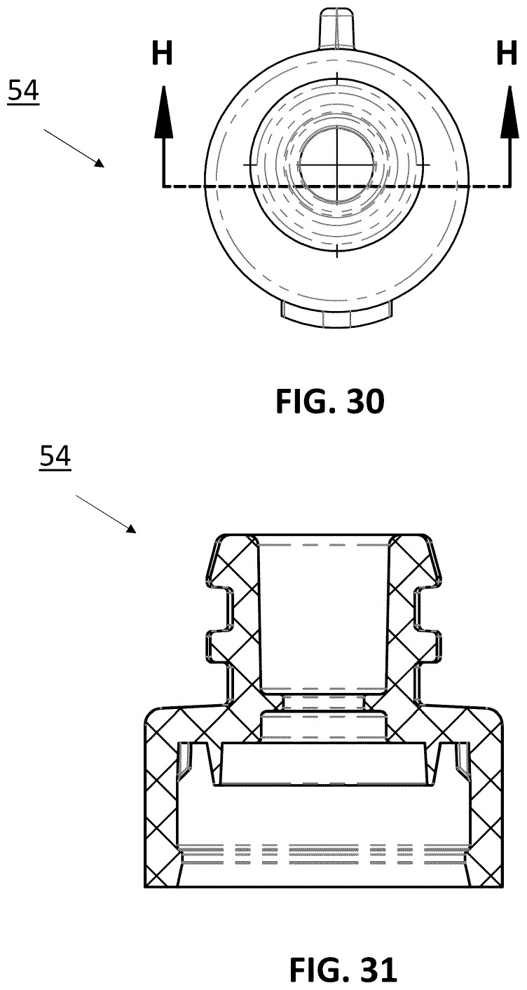

FIGS. 25-32 depict various views of cartridge cap 54, including alignment markers 58 and alignment protrusions 55, with FIGS. 29 and 31 cross sectional views taken along G-G and H-H of FIGS. 28 and 30, respectively. It is notable that the longitudinal axis of the uppermost portion of cartridge cap 54 including cross slit valve 53 and cartridge cap outlet 59, coined upper cartridge axis 66, is preferably not aligned with the longitudinal axis of the flavor receptacle 52, coined receptacle axis 67. This orientation is delineated in FIGS. 27 and 32. Advantages of this incongruous orientation include proper insertion and label visibility.

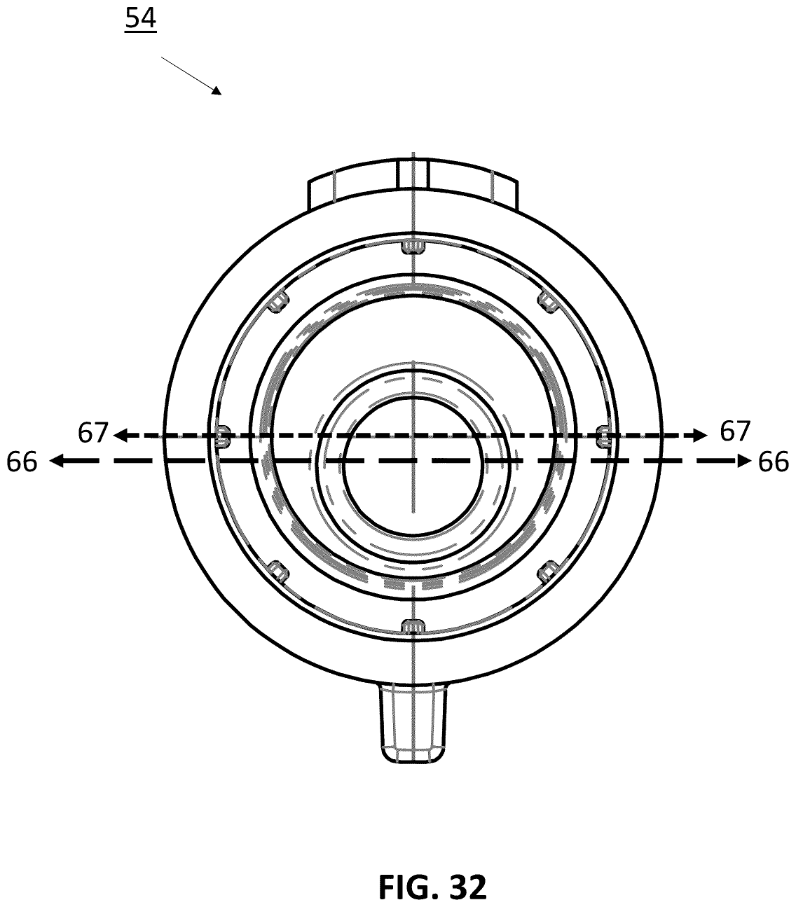

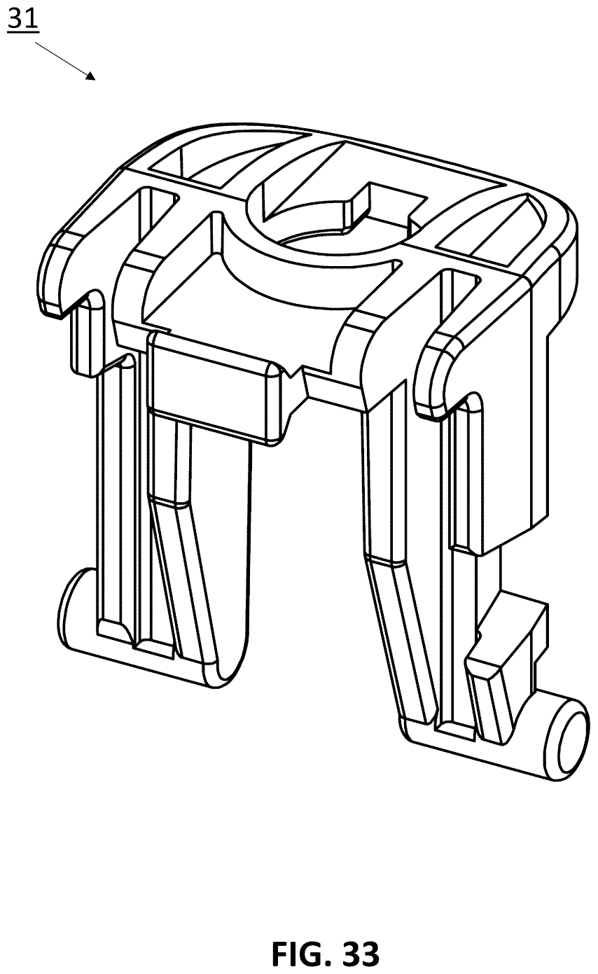

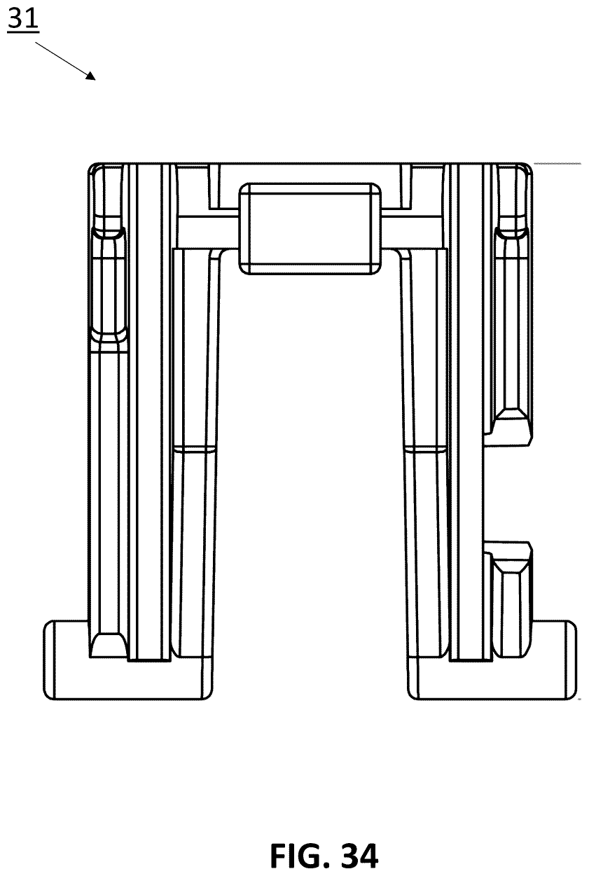

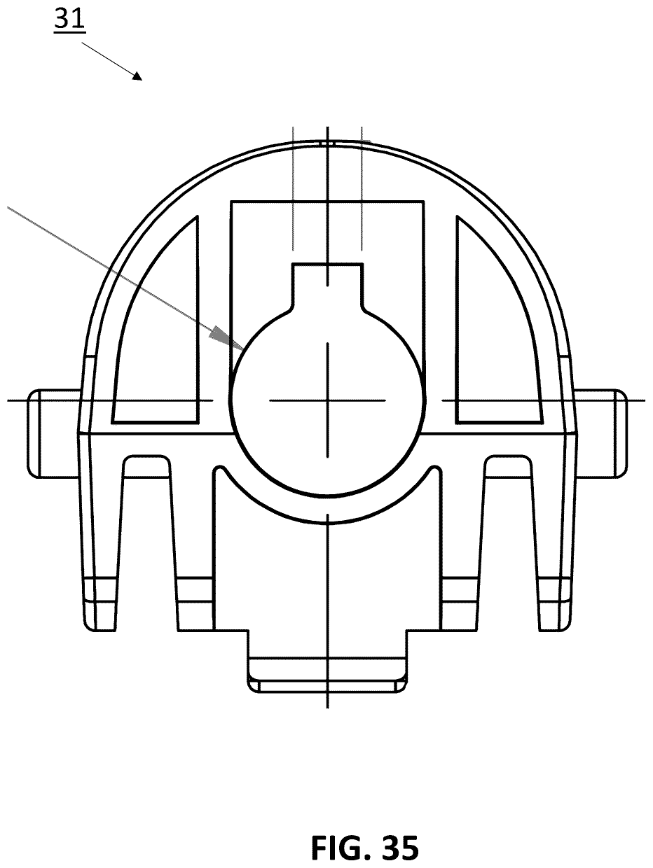

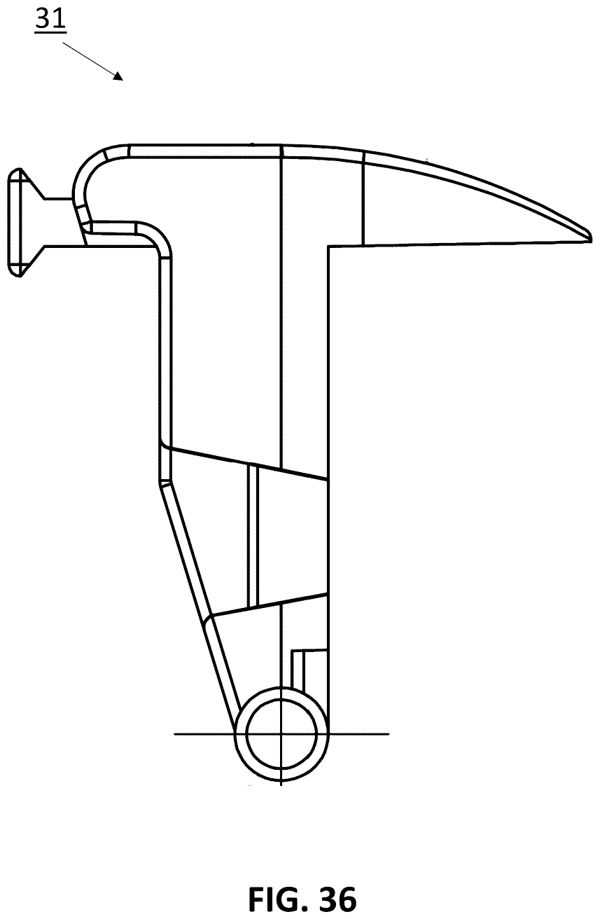

FIGS. 33-36 depict cam lever 31 in perspective, front, top and side views, respectively.

FIG. 37 depicts various essential steps, and structural and functional features associated with the beverage system. FIG. 37A shows a user holding beverage system 10 with door 38 closed. FIG. 37B shows first door 38 about to be opened. FIG. 37C shows cartridge 50 being inserted into cartridge housing 32. FIG. 37D shows ratchet bar 34 aligned but not engaged with cartridge 50. FIG. 37E shows ratchet bar 34 being engaged with cartridge 50. FIG. 37F shows door 38 being closed. It is noted that label 57 will be visible through viewing window 37 upon closure of door 38. FIG. 37G shows user screwing off vessel lid 25. FIG. 37H shows vessel lid 25 removed and diluent 60, e.g., water, being introduced into vessel 20. In FIG. 37I, vessel lid 25 is screwed back on. FIG. 37J shows sliding pawl 35 being actuated, thereby releasing flavor concentrate 62 (not shown) into diluent 60 (not shown) to create beverage 64 (not shown).

As previously set forth, opposing side of beverage system 10 includes a substantially similar door, cartridge assembly, sliding pawl and so forth. Accordingly, a user could employ the same steps set forth herein to insert and actuate a second cartridge that can be used simultaneously and/or as a “backup” for the first cartridge. In this manner the user can independently vary the volume of each flavor concentration, and ratio of each flavor concentration to the other, to create a beverage to their liking. By way of example one user may desire a subtle beverage having an equal balance of watermelon and lime flavoring, while another user may desire a strongly flavored beverage heavy on the watermelon with just a hint of lime. Beverage 54 is ready to be consumed in the ordinary manner, namely removing spout cover 29 and drinking from vessel spout 26 underneath.

In regular use beverage system 10 is utilized with two canisters inserted, but it is within the scope of the invention to include plugs or passive elastomeric valves of various configurations in order to facilitate using one canister without leakage into the open port.

It should be understood that the foregoing relates to exemplary embodiments of the invention and that modifications may be made without departing from the spirit and scope of the invention as set forth in the following claims. By way of example, the beverage system described herein accommodates two cartridges, but a single cartridge, or more than two cartridges is within the scope of this invention. Also, critical components of the system can be used in a large scale drink dispensing system, for example one found in a restaurant, or a drink production system, for example a counter-top device used in a home. Also, cartridges may be refillable with flavor concentrate, versus being disposable after one use. Terms such as “substantially” and the like shall mean within reasonable bounds when considering limitations such as machines, materials, manufacturing methods, and people. By way of example, a “substantially smooth” surface means there are no intentional bumps or irregularities. All ranges set forth herein include the endpoints as well as all increments there between, even if not specifically stated. By way of example 1 to 2 inches includes 1 inch, 1.000001 inches and so forth. It is also noted that “first” and “second” and the like are used to refer to duplicate structures, and the absence of a qualifier generally refers to the structure and not specifically the first or second of that structure. Moreover, redundant recitations of “first”, “second” and the like are omitted for simplicity where the nature of the structure would be understood based on the specification as a whole. Finally, unless otherwise stated or contrary to common sense, “approximate” and the like shall mean +/−10%.

What is claimed is:

1. A beverage system including;
A. A vessel defining at least one longitudinal channel;
B. A cartridge assembly engaged with said longitudinal channel, said cartridge assembly including an elongated cartridge housing and an elongated openable and closable door having a viewing window; and
C. A cartridge including a volume of concentrated matter, said cartridge engageable with said cartridge housing wherein said cartridge is viewable through said viewing window when said door is closed.

2. The beverage system of claim 1 wherein said concentrated matter is a flavor concentrate.

3. The beverage system of claim 1 wherein said cartridge assembly includes a sliding pawl for actuating the release of aliquots of said concentrated matter.

4. The beverage system of claim 3 wherein said door defines a sliding pawl aperture, said sliding pawl accessible through said sliding pawl aperture when said door is in closed position.

5. The beverage system of claim 1 wherein said vessel includes a chamber for storing a liquid diluent.

6. The beverage system of claim 5 wherein said concentrated matter is incrementally dispensed into said chamber.

7. A cartridge engageable with the vessel of a beverage system, said cartridge including:
A. A flavor receptacle having a first axis and including a volume of concentrated matter;
B. A plunger engaged with said flavor receptacle, said plunger for advancing said volume of concentrated matter through said flavor receptacle;
B. A cartridge cap having a second axis, said cartridge cap engaged with said flavor receptacle; and
C. A valve engaged with said cartridge cap, said valve configured to permit the egress of aliquots of said concentrated matter from said flavor receptacle.

8. The cartridge of claim 7 further including at least one alignment protrusion configured to releasably engage with an alignment protrusion receiver of said vessel, wherein said engagement permits actuation of said plunger by said vessel.

9. The cartridge of claim 8 wherein said alignment protrusion receiver is a notch defined by said vessel.

10. The cartridge of claim 7 further including at least one alignment marker configured to be viewable upon proper engagement of said cartridge with said vessel, wherein said proper engagement permits actuation of said plunger by said vessel.

11. The cartridge of claim 7 wherein said first axis and said second axis are not aligned.

12. A method of preparing a customized beverage including the acts of:
A. Opening a longitudinally-oriented first hinged door on a drinking vessel and inserting a first cartridge, said first cartridge containing a first concentrated matter;
B. Adding a diluent to the chamber of said drinking vessel;
C. Actuating the delivery of at least one aliquot of said first concentrated matter to said diluent.

13. The method of claim 12 further including the act of opening a longitudinally-oriented second hinged door on said drinking vessel and inserting a second cartridge, said second cartridge containing a second concentrated matter.

14. The method of claim 13 further including the act of actuating the delivery of at least one aliquot of said second concentrated matter to said diluent.

15. The method of claim 12 wherein said act of actuating the delivery of at least one aliquot of said first concentrated matter to said diluent includes the act of depressing a first sliding pawl.

16. The method of claim 12 wherein said act of inserting a first cartridge includes the act of inserting a first cartridge having an upper cartridge axis and a receptacle axis, wherein said upper cartridge axis is not longitudinally aligned with said receptacle axis.

17. The method of claim 12 further including the act of removing said first cartridge upon depletion of said first concentrated matter.
